(19) United States
(12) Patent Application Publication
(10) Pub. No.: US 2008/0088496 A1
(43) Pub. Date: Apr. 17, 2008

(54) System and Method for Protecting Means of Transport From IR-Guided Missiles

(75) Inventors: Andrea Thum-Jäeger, Neufahrn (DE); Bernhard Molocher, Bockhorn (DE); Rudolf Protz, Hoehenkirchen (DE); Rainer Ackermann, Augsburg (DE)

Correspondence Address: CROWELL & MORING LLP;INTELLECTUAL PROPERTY GROUP, P.O. BOX 14300, WASHINGTON, DC, 20044-4300, US

(73) Assignee: EADS Deutschland GmbH, Ottobrunn (DE)

(21) Appl. No.: 10/576,928

(22) PCT Filed: Oct. 21, 2004
(86) PCT No.: PCT/DE04/02345

§ 371 Date: Mar. 2, 2007

(30) Foreign Application Priority Data
Oct. 25, 2003 (DE) 103 49 869.9

(51) Int. Cl. G01S 7/495

(52) U.S. Cl. 342/14; 342/54

(57) ABSTRACT

A system for protecting a vehicle against IR-guided missiles, includes at least one missile warning device, and a device for jamming IR-guided missiles. A laser array is coupled to the at least one missile warning devices for jamming the IR-guided missiles.

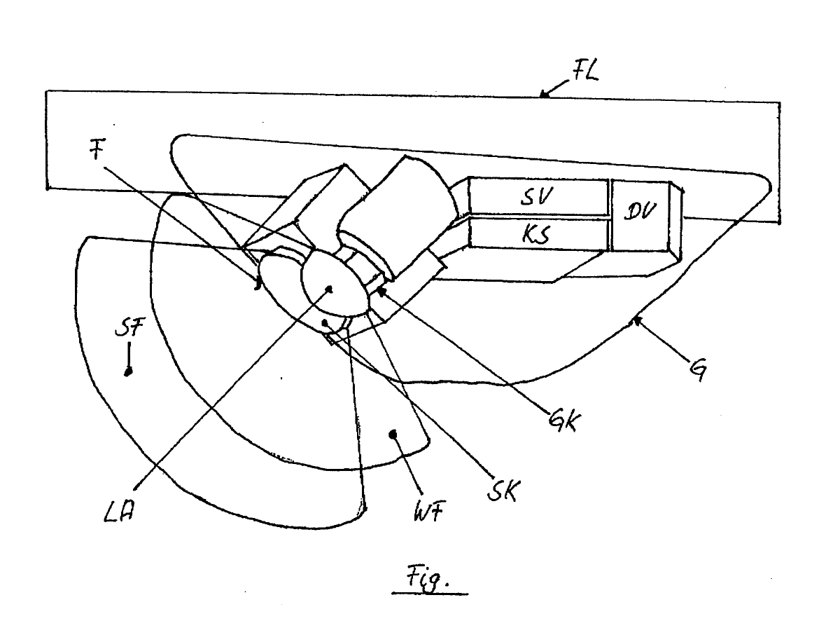

This application is a National Phase of PCT/DE2004/002346, filed Oct. 21, 2004, which claims the priority German patent document DE 103 49 869.9, filed Oct. 25, 2003, the disclosures of which are expressly incorporated by reference herein.

### BACKGROUND AND SUMMARY OF THE INVENTION

The invention relates to a method and apparatus for protection of vehicles against IR-guided missiles.

Weapon systems with missile warning devices for self-defense of aircraft are known. Such systems attack missiles with IR homing heads by aiming broadband IR radiation from lamps (focused as well as possible), or in the case of DIRCM (directional infrared countermeasures) weapon systems narrowband IR laser radiation, at the homing head of the attacking missile. Such a DIRCM-weapon system is disclosed, for example, in German patent document DE 197 45 785.

One disadvantage of weapon systems in which IR radiation is directed at the attacking missiles by means of lamps is the heavy weight and the large volume of the system. Further disadvantages are the poor efficiency of the system because of a low interference-to-signal ratio, and high power consumption. In the case of laser DIRCM weapon systems, on the other hand, so-called trackers are normally required to track the attacking missiles, thus making the system design complex.

Other weapon systems are based on the ejection of decoys, or so-called flares. One disadvantage of such systems, however, is that it is very dangerous to handle explosive materials in an aircraft, in particular in a commercial aircraft. Furthermore, when flares are ejected at a low altitude, there is a risk of setting fire to the environment located underneath, for example fields and woods.

One object of the present invention, therefore, is to provide a system of this generic type which has a compact and simple design, and is highly effective for defense against attacking missiles.

A further object of the invention is to provide a method for operation of the system.

These and other objects and advantages of the invention are achieved by the method and apparatus according to the invention, in which a laser array is coupled to the missile warning appliance in order to jam IR-guided missiles. In one advantageous embodiment of the invention, the laser array comprises a number of laser diodes, normally several hundred. One advantage of this arrangement is its compact and simple design, such that the system can easily be fitted, for example, to an aircraft, to a ground vehicle or to a ship. Since laser diodes are considerably smaller than conventional lasers or lamps, it is possible to fit laser diode arrays on both flat and curved surfaces. This substantially increases the effective radius of the array, thus leading to an improvement in the effectiveness of the weapon system.

The laser diodes advantageously operate at a wavelength in the range from 2-5 μm, expediently with an output power of 1 KW/cm² at a temperature of 300 K. It is, of course, possible to subdivide the wavelength ranges of the laser diodes. For example, it is possible to provide for a first portion of the laser diodes to cover a wavelength range from 2-3.5 μm, and for a second portion of the laser diodes to cover the wavelength range from 3.5-5 μm. The two types of laser diodes may in this case be arranged as required or in accordance with a predeterminable pattern on the laser diode array.

In further advantageous embodiments of the invention, the laser array comprises diode-pumped semiconductor lasers, diode-pumped wafer lasers, or diode-pumped semiconductor wafer lasers. It is, of course, possible to construct a laser array from a combination of the stated lasers.

Other objects, advantages and novel features of the present invention will become apparent from the following detailed description of the invention when considered in conjunction with the accompanying drawings.

### BRIEF DESCRIPTION OF THE DRAWINGS

The single FIGURE shows the system according to the invention in an exemplary outline illustration.

### DETAILED DESCRIPTION FO THE DRAWING

Referring to the drawing, reference symbol G denotes a housing, which surrounds the system components, in particular the missile warning appliance F. The FIGURE also shows the laser array LA which is arranged on a hinged bearing GK, the electrical power supply SV and the cooling systems KS as well as the data processing unit DV. A further system, which is not illustrated but is located in the housing G, is an imaging sensor for reading the data from the sensor heads SK of the missile warning appliance F. Means (not illustrated) are expediently also provided on it to allow the housing G to be fitted to the outer skin of an aircraft FL.

The missile warning appliance F is advantageously aligned in a predeterminable spatial direction. The field of view SF of the missile warning appliance F in this case advantageously covers a spatial angle of 90°. The spatial direction of the line of sight of the missile warning appliance is in this case governed in particular by the position on the aircraft at which the system according to the invention is fitted. For example, the missile warning appliance F is aligned at 45° to the direction of flight in a system which is intended for installation in the nose of the aircraft. The missile warning appliance F is preferably aligned at 90° to the direction of flight in a system which is intended, for example, for installation on the underneath side of the aircraft. This ensures that the entire area surrounding an aircraft can be covered by the sensors with a total of, for example, 4-6 systems.

The effective field WF of the laser array LA is advantageously greater than or equal to the field of view SF of the missile warning appliance F. This ensures that the effective fields WF of a plurality of systems which are fitted to the aircraft provide coverage, thus ensuring that the defensive measures are more efficient. Furthermore, it is thus possible to simultaneously jam a plurality of objects which are detected in the field of view SF of the missile warning appliance F and may be identified as a threat.

The operation of a system according to the invention will be described in detail in the following text.

The sensor heads SK of the missile warning appliance F cover a field of view SF in which the signal of an approaching object (not illustrated) can be detected. The signals from the sensor heads SK of the missile warning appliance F are read by the imaging sensor, and are processed further in order to identify and to track the detected object. During the signal evaluation by the imaging sensor or by further systems which are not illustrated but are connected to the imaging sensor, the exhaust gas jet, in particular, of the approaching object is evaluated, taking into account predeterminable parameters, such as temperature and length. This information is compared by the system according to the invention with the behavior of an attacking rocket, thus making it possible to make a statement with regard to the threat from the approaching object against the aircraft to be protected.

If the approaching object is classified as a threat for the aircraft to be protected, a warning signal is sent to the data processing unit DV. This warning signal in this case expediently comprises precise details of the attacking object, in particular the height and the azimuth direction. The data processing unit DV is in this case expediently a tactical computer, which continues to track the object.

It is, of course, possible for the sensor heads SK of the missile warning appliance F to identify a plurality of objects as a threat. In this case, a plurality of warning signals are sent to the data processing unit DV, which sorts possible defensive measures on the basis of the relevance of the threat.

The data processing unit DV calculates the direction of the object to be defended on the basis of the warning signals. The line of sight of the laser array LA is aligned in this direction. The laser array LA is in this case advantageously aligned by means of the hinged bearing GK on which the laser array LA is arranged. The hinged bearing GK is expediently mounted by means of two shafts (not illustrated), which ensures that the line of sight of the laser array LA can be quickly and reliably aligned in any desired spatial direction.

For defense against and jamming of the attacking IR-guided object, the laser array LA transmits a laser beam, in particular a modulated laser beam, in the predetermined direction.

In order to improve the reaction time of the system for initiation of countermeasures, it is advantageously possible to provide for the line of sight of the laser array to be aligned in the direction of a detected object even before it is possibly identified as a threat.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1: A system for protecting a vehicle against IR-guided missiles, comprising:
at least one missile warning device; and
means for jamming IR-guided missiles;
wherein a laser array is coupled to the at least one missile warning devices for jamming the IR-guided missiles.

2: The system as claimed in claim 1, wherein the laser array comprises a plurality of laser diodes with a wavelength in the range from 2-5 μm.

3: The system as claimed in claim 1, wherein the laser array comprises a plurality of diode-pumped semiconductor lasers.

4: The system as claimed in claim 1, wherein the laser array comprises a plurality of diode-pumped wafer lasers.

5: The system as claimed in claim 1, wherein the laser array comprises a plurality of diode-pumped semiconductor wafer lasers.

6: The system as claimed in claim 1, wherein the system is enclosed in a housing.

7: The system as claimed in one of the claim 1, wherein the at least one missile warning device is aligned in a predeterminable spatial direction.

8: The system as claimed in claim 1, wherein a spatial angle of a field of view of the at least one missile warning device is approximately 90°.

9: The system as claimed in claim 8, wherein an effective field of the laser array (LA) is greater than or equal to the field of view of the at least one missile warning device.

10: The system as claimed in claim 1, wherein the laser array is fitted to a hinged bearing, which is mounted by means of at least two shafts.

11: The system as claimed in claim 10, wherein a data processing unit is provided for controlling spatial alignment of a line of sight of the laser array.

12: The system as claimed in claim 1, wherein the system is adapted to be fitted to the outer skin of a vehicle.

13: The system as claimed in claim 12, wherein connections are provided for production of one of an electrical power supply and a data supply with the vehicle.

14: A vehicle having at least one system as claimed in claim 1.

15. (canceled)

16: The method as claimed in claim 19, wherein, if a plurality of attacking missiles are detected, countermeasures are carried out as a function of relevance of the threat.

17: The method as claimed in claim 15, wherein a line of sight of the laser array is aligned in a direction of an object which is identified as a threat.

18: The method as claimed in claim 15, wherein a line of sight of the laser array (LA) is aligned in the direction of a detected object.

19: A method of protecting a vehicle against an IR-guided missile, said method comprising:
detecting approach of an IR-guided missile; and
illuminating the IR-guided missile with radiation generated from a laser array which comprises a multiplicity of laser diodes.

20: A system for protecting a vehicle against IR-guided missiles, comprising:
means for detecting approach of an object toward the vehicle;
means for identifying the object as a threat; and
means responsive to identification of the object as a threat, for jamming guidance of the object by irradiating a guidance system thereof;
wherein the means for irradiating the object comprises a laser array.
